(19) United States
(12) Patent Application Publication
(10) Pub. No.: US 2026/0171310 A1
(43) Pub. Date: Jun. 18, 2026

(54) MULTILAYER ELECTRONIC COMPONENT

(71) Applicant: SAMSUNG ELECTRO-MECHANICS CO., LTD., Suwon-si (KR)

(72) Inventors: Seol Ah CHONG, Suwon-si (KR); Hwa Young LEE, Suwon-si (KR); Sang Woo KIM, Suwon-si (KR); Hye Sung YOON, Suwon-si (KR); San KYEONG, Suwon-si (KR)

(73) Assignee: SAMSUNG ELECTRO-MECHANICS CO., LTD., Suwon-si (KR)

(21) Appl. No.: 19/362,645

(22) Filed: Oct. 20, 2025

(30) Foreign Application Priority Data
Dec. 12, 2024 (KR) 10-2024-0185090

(51) Int. Cl. H01G 4/008; H01G 4/12; H01G 4/30

(52) U.S. Cl. CPC H01G 4/0085; H01G 4/1227; H01G 4/30

(57) ABSTRACT

A multilayer electronic component includes a body including a dielectric layer and an internal electrode alternately disposed with the dielectric layer; and an external electrode disposed on the body, wherein the internal electrode includes a plurality of electrode portions and a plurality of disconnected portions, and a filler including Y, Si, and O is disposed in at least one of the plurality of disconnected portions, and the dielectric layer includes BaTiO₃ and (Ba₁₋ₓCaₓ)TiO₃, where x may be greater than 0 and less than 1.0.

### CROSS-REFERENCE TO RELATED APPLICATION(S)

This application claims benefit of priority to Korean Patent Application No. 10-2024-0185090 filed on Dec. 12, 2024, the disclosure of which is incorporated herein by reference in their entireties.

### TECHNICAL FIELD

The present disclosure relates to a multilayer electronic component.

A multilayer ceramic capacitor (MLCC), a multilayer electronic component, may be a chip-type condenser mounted on printed circuit boards of various electronic products, such as an imaging device, including a liquid crystal display (LCD) or a plasma display panel (PDP), a computer, a smartphone, or a mobile phone, serving to charge or discharge electricity therein or therefrom.

Such a multilayer ceramic capacitor has a small size, implements high capacitance, and is easily mounted on a circuit board, and may thus be used as a component of various electronic devices.

In a manufacturing process of a multilayer ceramic capacitor, sintering of an internal electrode occurs first before a dielectric layer is sintered. In this case, as the internal electrode shrinks, a space filled by an electrode remains as a defect, and stress is concentrated in a portion in which the remaining electrodes are connected. Accordingly, cracks may occur or propagate, causing disconnection of the internal electrode. Such a disconnection phenomenon of the internal electrode may become more severe as the internal electrode becomes thinner, which may act as a main cause of deterioration in the characteristics of the multilayer ceramic capacitor. In addition, excessive disconnection of the internal electrode may cause pores inside the body, which may cause excessive sintering shrinkage of the dielectric layer, and moisture may easily penetrate into a portion of the pores making the internal electrode vulnerable to oxidation.

Therefore, a method is required to improve reliability, and preserve electrical characteristics by supplementing a disconnected portion of the internal electrode.

### SUMMARY

An aspect of the present disclosure is to provide a multilayer electronic component having excellent reliability.

An aspect of the present disclosure is to provide a multilayer electronic component in which the occurrence and propagation of cracks are suppressed.

An aspect of the present disclosure is to provide a multilayer electronic component having excellent high-temperature stability and high-temperature reliability.

However, various problems to be solved by the present disclosure are not limited to the above-described contents, and can be more easily understood in the process of explaining specific embodiments of the present disclosure.

According to an aspect of the present disclosure, a multilayer electronic component includes a body including a dielectric layer and an internal electrode alternately disposed with the dielectric layer; and an external electrode disposed on the body, wherein the internal electrode includes a plurality of electrode portions and a plurality of disconnected portions, and a filler including Y, Si, and O is disposed in at least one of the plurality of disconnected portions, and the dielectric layer includes BaTiO₃ and (Ba₁₋ₓCaₓ)TiO₃, where x may be greater than 0 and less than 1.0.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure;

FIG. 2 schematically illustrates a cross-sectional view of FIG. 1, taken along line I-I′;

FIG. 3 schematically illustrates a cross-sectional view of FIG. 1, taken along line II-II′;

FIG. 4 schematically illustrates a disassembled body;

FIG. 5 is an enlarged view of region K1 of FIG. 3;

FIG. 6 schematically illustrates an enlarged view of an internal electrode;

FIG. 7 is an image of an internal electrode according to an embodiment of the present disclosure, scanned by SEM;

FIG. 8 is an image of Ni element distribution in the region of FIG. 7, analyzed by SEM-EDS;

FIG. 9 is an image of Y element distribution in the region of FIG. 7, analyzed by SEM-EDS;

FIG. 10 is an image of O element distribution in the region of FIG. 7, analyzed by SEM-EDS; and

FIG. 11 is an image of Si element distribution in the region of FIG. 7, analyzed by SEM-EDS.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, an X direction may be defined as a first direction, a stacking direction, or a thickness (T) direction, a Y direction may be defined as a second direction or a length (L) direction, and a Z direction may be defined as a third direction or a width (W) direction.

### Multilayer Electronic Component

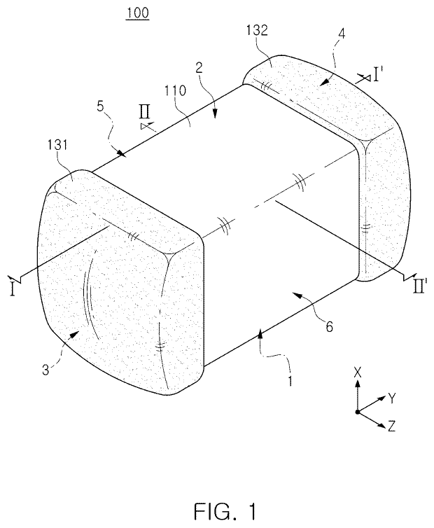

FIG. 1 schematically illustrates a perspective view of a multilayer electronic component according to an embodiment of the present disclosure.

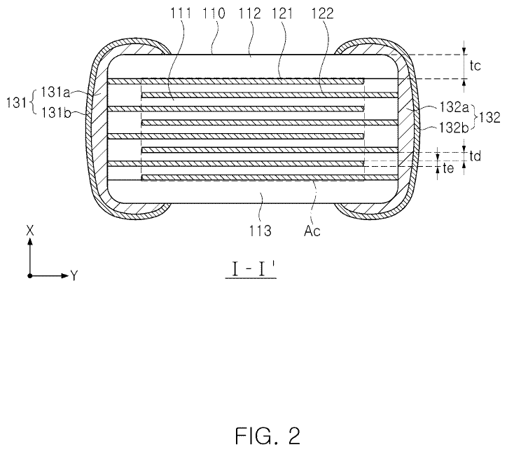

FIG. 2 schematically illustrates a cross-sectional view of FIG. 1, taken along line I-I′.

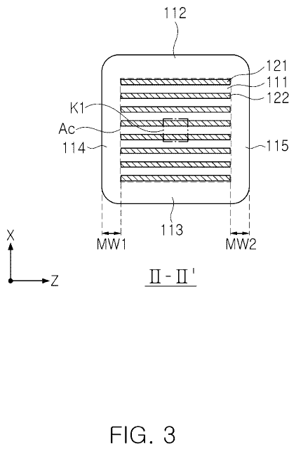

FIG. 3 schematically illustrates a cross-sectional view of FIG. 1, taken along line II-II′.

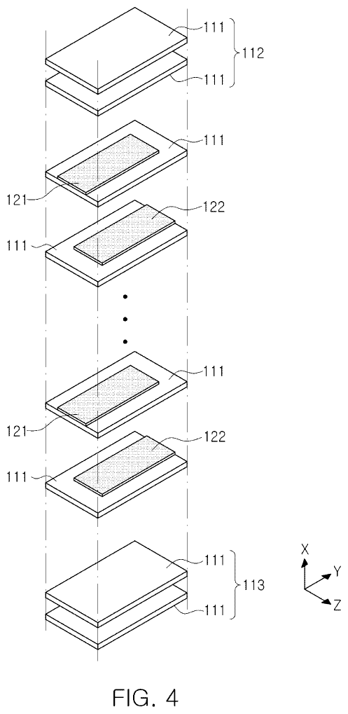

FIG. 4 schematically illustrates a disassembled body.

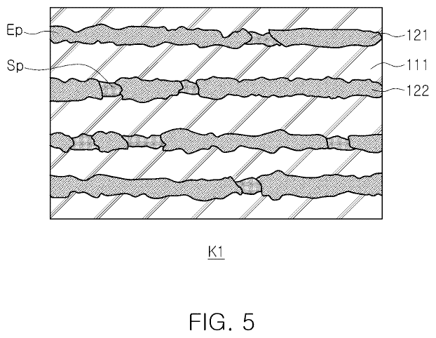

FIG. 5 is an enlarged view of region K1 of FIG. 3.

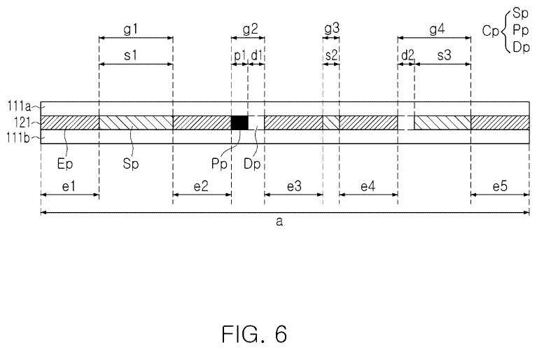

FIG. 6 schematically illustrates an enlarged view of an internal electrode.

Hereinafter, a multilayer electronic component 100 according to an embodiment of the present disclosure will be described in detail with reference to FIGS. 1 to 6. In addition, a multilayer ceramic capacitor (hereinafter, referred to as ‘MLCC’) will be described as an example of a multilayer electronic component, but the present disclosure is not limited thereto, and may also be applied to various multilayer electronic components using a ceramic material, such as an inductor, a piezoelectric element, a varistor, a thermistor, or the like.

According to an aspect of the present disclosure, the multilayer electronic component 100 includes a body 110 including a dielectric layer 111 and internal electrodes 121 and 122 alternately disposed with the dielectric layer; and external electrodes 131 and 132 disposed on the body, wherein the internal electrode includes a plurality of electrode portions Ep and a plurality of disconnected portions Cp, wherein a filler Sp including Y, Si, and O may be disposed in at least one of the plurality of disconnected portions Cp, and the dielectric layer 111 may include BaTiO₃ and (Ba₁₋ₓCaₓ)TiO₃, where x may be greater than 0 and less than 1.0.

Since a sintering shrinkage behavior of the internal electrodes and the dielectric layer is different during a sintering process, disconnection of the internal electrodes may occur, and thus, the internal electrodes 121 and 122 includes a disconnected portion Cp in addition to an electrode portion Ep. In general, the disconnected portion Cp of the internal electrode is formed by pores Pp, and the pores Pp may act as microcracks inside the body, which can cause the occurrence and propagation of cracks, induce excessive shrinkage of the dielectric layer, and make it easy for moisture to penetrate into a portion of the pores, making the internal electrode vulnerable to oxidation.

According to an embodiment of the present disclosure, when a filler Sp including Y, Si, and O is disposed in the disconnected portion Cp, the excessive shrinkage of the dielectric layer 111 may be prevented, and the penetration of moisture may be prevented, thereby preventing the oxidation of the internal electrodes 121 and 122.

In addition, when a material and/or sintering conditions of the internal electrodes 121 and 122 are significantly changed in order to suppress the disconnected portion Cp, non-sintering of the dielectric layer 111 may occur, but according to an embodiment of the present disclosure, the disconnected portion Cp may be supplemented without significantly changing the sintering conditions.

Hereinafter, each component included in the multilayer electronic component 100 according to some embodiments of the present disclosure will be described.

The body 110 may have a dielectric layer 111 and internal electrodes 121 and 122 alternately stacked.

Although the specific shape of the body 110 is not particularly limited, the body 110 may have a hexahedral shape or a shape similar to the hexahedral shape, as illustrated in the drawings. Due to shrinkage of ceramic powder particles included in the body 110 during a sintering process, the body 110 may not have a hexahedral shape having a perfectly straight line, but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

As a margin region in which the internal electrodes 121 and 122 are not disposed overlaps the dielectric layer 111, a step portion may be formed by thicknesses of the internal electrodes 121 and 122, so that a corner connecting the first surface to the third to fifth surfaces and/or a corner connecting the second surface to the third to fifth surfaces may have a shape contracted to a center of the body 110 in the first direction when viewed with respect to the first surface or the second surface. Alternatively, by shrinkage behavior during the sintering process of the body 110, a corner connecting the first surface 1 to the third to sixth surfaces 3, 4, 5, and 6 and/or a corner connecting the second surface 2 to the third to sixth surfaces 3, 4, 5, and 6 may have a shape contracted to the center of the body 110 in the first direction when viewed with respect to the first surface or the second surface. Alternatively, as a corner connecting respective surfaces of the body 110 to each other is rounded by performing an additional process to prevent chipping defects, or the like, the corner connecting the first surface to the third to sixth surfaces and/or the corner connecting the second surface to the third to sixth surfaces may have a rounded shape.

Meanwhile, in order to suppress a step portion formed by the internal electrodes 121 and 122, after the internal electrodes are cut so as to be exposed to the fifth and sixth surfaces 5 and 6 of the body after lamination, when margin portions 114 and 115 are formed by stacking a single dielectric layer or two or more dielectric layers on both side surfaces of the capacitance formation portion Ac in a third direction (width direction), a portion connecting the first surface to the fifth and sixth surfaces and a portion connecting the second surface to the fifth and sixth surfaces may not have a contracted form.

The dielectric layer 111 may include BaTiO₃ and (Ba₁₋ₓCaₓ)TiO₃ (0<x<1).

BaTiO₃ is a ferroelectric material that has high permittivity at room temperature, a relatively small dissipation factor, and excellent insulation resistance characteristics. However, when the dielectric layer includes only BaTiO₃ as a main component, a Curie Temperature (Tc) is around 125° C., and the permittivity decreases rapidly in the high temperature range of 150° C., making it difficult to satisfy the X8R characteristics (−55° C. to 150° C., capacitance deviation of within ±15%) specified in the EIA (Electronic Industries Association) standards.

On the other hand, in order to implement high-temperature characteristics, (Ba₁₋ₓCaₓ)TiO₃ (hereinafter referred to as “BCT”) in which Ca is dissolved as a base powder is applied, Ca²⁺ is doped in a Ba-site, which reduces a lattice energy due to off-center displacement of Ca ions, thereby improving structural stability at high temperatures, and thus improving temperature coefficient of capacitance (TCC) at high temperatures. However, BCT has a high change in permittivity according to an AC electric field, and side effects such as a decrease in an RC value at room temperature and an increase in DF may occur.

Accordingly, in the present disclosure, the dielectric layer 111 simultaneously includes BaTiO₃ and (Ba₁₋ₓCaₓ)TiO₃ (0<x<1), thereby satisfying the X8R characteristics (−55° C. to 150° C., capacitance deviation of within ±15%) while reducing the occurrence of side effects due to the use of BCT.

In some embodiments, the dielectric layer 111 includes BaTiO₃ and (Ba₁₋ₓCaₓ)TiO₃ (0<x<1), where x may satisfy 0.025 or more and 0.2 or less.

Accordingly, the high-temperature characteristics may be further improved and the occurrence of side effects due to the use of BCT may be further reduced.

When x is less than 0.025, it may be difficult to secure high-temperature characteristics, and when x exceeds 0.2, there may be a concern that the side effects due to the use of BCT may increase.

In some embodiments, the dielectric layer 111 may include (Ba₁₋ₓCaₓ)TiO₃ in an amount of 10 mol % or more and 95 mol % or less relative to a total content of BaTiO₃ and (Ba₁₋ₓCaₓ)TiO₃. Accordingly, the high-temperature characteristics may be further improved and the occurrence of side effects due to the use of BCT may be further reduced.

When the content of (Ba₁₋ₓCaₓ)TiO₃ is less than 10 mol % relative to the total content of BaTiO₃ and (Ba₁₋ₓCaₓ)TiO₃, it may be difficult to secure high-temperature characteristics, and when the content of (Ba₁₋ₓCaₓ)TiO₃ is less than 95 mol %, there may be a concern that the side effects due to the use of BCT may increase.

A plurality of dielectric layers 111 forming the body 110 may be in a sintered state, and adjacent dielectric layers 111 may be integrated with each other, such that boundaries therebetween may not be readily apparent without use of a scanning electron microscope (SEM). The number of stacked dielectric layers is not particularly limited, and may be determined by considering the size of the multilayer electronic component. For example, 400 or more dielectric layers may be stacked to form a body.

The dielectric layer 111 may be formed by manufacturing a ceramic slurry including a ceramic powder particle, an organic solvent, and a binder, applying the slurry to a carrier film and drying the same to prepare a ceramic green sheet, and then sintering the ceramic green sheet.

The ceramic powder particle may be used by mixing BaTiO₃ powder particles and (Ba₁₋ₓCaₓ)TiO₃ (0<x<1) powder particles. Therefore, the dielectric layer 111 may include BaTiO₃ and (Ba₁₋ₓCaₓ)TiO₃ (0<x<1) as main components.

The present disclosure may be applied to various sizes of chips from a chip size of 0201 (length 0.2 mm, width 0.1 mm) to a chip size of 5750 (length 5.7 mm, width 5.0 mm). Therefore, an average thickness “td” of the dielectric layer 111 is not particularly limited, but may be, for example, 30 μm. In addition, the average thickness “td” of the dielectric layer 111 may be arbitrarily set according to the desired characteristics or purpose.

Here, the average thickness “td” of the dielectric layer 111 refers to a size of the dielectric layer 111 in the first direction disposed between the internal electrodes 121 and 122. The average thickness of the dielectric layer 111 may be measured by scanning images of cross-sections of the body 110 in the first and second directions with a scanning electron microscope (SEM) at a magnification of 10,000. More specifically, an average value may be measured by measuring a thickness of one dielectric layer 111 at a plurality of points of one dielectric layer 111, for example, at 30 equally spaced points in the second direction. The 30 equally spaced points may be designated in a capacitance formation portion Ac to be described later. In addition, if the average value is measured by extending the average value measurement to 10 dielectric layers 111, the average thickness of the dielectric layers may be further generalized.

The body 110 may include a capacitance formation portion Ac disposed in the body 110, and including a first internal electrode 121 and a second internal electrode 122 disposed to oppose each other with the dielectric layer 111 interposed therebetween and having capacitance formed therein, and cover portions 112 and 113 formed above and below the capacitance formation portion Ac in the first direction.

In addition, the capacitance formation portion Ac is a portion serving to contribute to capacitance formation of a capacitor, and may be formed by repeatedly stacking a plurality of first and second internal electrodes 121 and 122 with a dielectric layer 111 interposed therebetween.

The cover portions 112 and 113 may include an upper cover portion 112 disposed above the capacitance formation portion Ac in the first direction, and a lower cover portion 113 disposed below the capacitance formation portion Ac in the first direction.

The upper cover portion 112 and the lower cover portion 113 may be formed by stacking a single dielectric layer or two or more dielectric layers on the upper and lower surfaces of the capacitance formation portion Ac in a thickness direction, respectively, and the upper cover portion 112 and the lower cover portion 113 may serve to basically prevent damage to the internal electrodes due to physical or chemical stress.

The upper cover portion 112 and the lower cover portion 113 may not include internal electrodes, and may include the same material as that of the dielectric layer 111.

That is, the upper cover portion 112 and the lower cover portion 113 may include a ceramic material, for example, a barium titanate (BaTiO₃)-based ceramic material.

The present disclosure may be applied to various sizes of chips from a chip size of 0201 (length 0.2 mm, width 0.1 mm) to a chip size of 5750 (length 5.7 mm, width 5.0 mm). Therefore, a thickness of the cover portions 112 and 113 is not particularly limited. However, in order to more easily achieve miniaturization and high capacitance of the multilayer electronic component, the thickness “tc” of the cover portions 112 and 113 may be 800 μm or less.

The average thickness “tc” of the cover portions 112 and 113 may mean a size thereof in the first direction, and may be a value obtained by averaging sizes of the cover portions 112 and 113 in the first direction measured at 5 equally spaced points above or below the capacitance formation portion Ac.

In addition, margin portions 114 and 115 may be disposed on a side surface of the capacitance formation portion Ac.

The margin portions 114 and 115 may include a first margin portion 114 disposed on the fifth surface 5 of the body 110 and a second margin portion 115 disposed on the sixth surface 6 of the body 110. That is, the margin portions 114 and 115 may be disposed on both end surfaces of the ceramic body 110 in a width direction.

The margin portions 114 and 115 may mean a region between both ends of the first and second internal electrodes 121 and 122 and a boundary surface of the body 110 in a cross-section cut of the body 110 in the width-thickness (W-T) direction, as illustrated in FIG. 3.

The margin portions 114 and 115 may basically serve to prevent damage to the internal electrodes due to physical or chemical stress.

The margin portions 114 and 115 may be formed by applying a conductive paste to the ceramic green sheet, except where margin portions are to be formed, to form an internal electrode.

In addition, in order to suppress a step portion by the internal electrodes 121 and 122, after the internal electrodes are cut so as to be exposed to the fifth and sixth surfaces 5 and 6 of the body after lamination, the margin portions 114 and 115 may also be formed by stacking a single dielectric layer or two or more dielectric layers on both side surfaces of the capacitance formation portion Ac in the third direction (width direction).

The present disclosure may be applied to various sizes of chips from a chip size of 0201 (length 0.2 mm, width 0.1 mm) to a chip size of 5750 (length 5.7 mm, width 5.0 mm). Therefore, a width of the margin portions 114 and 115 is not particularly limited. For example, an average width of the margin portions 114 and 115 may be 800 μm or less.

The average width of the margin portions 114 and 115 may mean an average size MW1 in the third direction of a region in which the internal electrode is spaced apart from the fifth surface and an average size MW2 in the third direction of a region in which the internal electrode is spaced apart from the sixth surface, and may be a value averaging the sizes of the margin portions 114 and 115 in the third direction, measured at 5 equally spaced points on the side surface of the capacitance formation portion Ac.

Therefore, in some embodiments, each of the average sizes MW1 and MW2 in the third direction of the regions in which the internal electrodes 121 and 122 are spaced apart from the fifth and sixth surfaces may be 800 μm or less.

The internal electrodes 121 and 122 may include a plurality of electrode portions Ep and a plurality of disconnected portions Cp, and a filler Sp including Y, Si, and O may be disposed in at least one of the plurality of disconnected portions Cp.

In the prior art, there was an attempt to supplement a disconnected portion by including a Dy-based filler in the disconnected portion Cp. However, in the case of the Dy-based filler, there was a problem that it was difficult to secure high-temperature characteristics because deformation due to temperature change was large at high temperatures.

On the other hand, in the present disclosure, by disposing a filler Sp including Y, Si, and O in the disconnected portion Cp, high-temperature characteristics may be further improved, thereby ensuring thermal stability.

In some embodiments, the filler including Y, Si and O may include at least one of Y₂Si₂O₇ or Y₂SiO₅.

Table 1 below compares the Young's modulus and coefficient of thermal expansion (CTE) of Y₂Si₂O₇ and Dy₂Si₂O₇.

TABLE 1

| | | Young's | |
|---|---|---|---|
| | Crystal | modulus | CTE |
| Division | structure | (GPA) | (10⁻⁶ K⁻¹) |
| Y₂Si₂O₇ | α | 206 | 30.05 |
| (Yttrium silicate) | | | |
| Dy₂Si₂O₇ | α | 139 | 33.21 |
| (Dysprosium silicate) | | | |

Referring to Table 1 above, Y₂Si₂O₇, an oxide containing Y, Si, and O, has a relatively small coefficient of thermal expansion, as compared to Dy₂Si₂O₇, a Dy-based oxide, in the same structure, and thus deformation due to temperature changes may be reduced and excessive shrinkage of the dielectric may be prevented, and a stress concentration phenomenon between the internal electrode and the dielectric layer may be alleviated, and thermal fatigue may be reduced. Therefore, in order to secure high-temperature characteristics, when the dielectric layer 111 simultaneously includes BaTiO₃ and (Ba₁₋ₓCaₓ)TiO₃ (0<x<1), if a filler Sp including Y, Si, and O is disposed in the disconnected portion Cp, the high-temperature characteristics may be further improved to secure thermal stability.

In addition, Y₂Si₂O₇, a filler including Y, Si, and O, has a higher Young's modulus than Dy₂Si₂O₇, a Dy-based oxide, and therefore may increase the mechanical strength and durability in a ceramic electronic component used in high-temperature environments, and may have high resistance to repeated thermal cycling and reduce the possibility of the occurrence of thermal deformation and cracks.

In addition, the filler including Y, Si, and O has relatively low deformation due to stress, thereby reducing interlayer stress and enabling stable interlayer bonding even at high temperatures. A material having a higher Young's modulus has higher resistance to physical stresses such as mechanical shocks and vibrations, making the material advantageous for use in extreme applications such as in the areas of defense, aerospace, and automotive electronics.

Hereinafter, unless specifically limited, the filler in the present disclosure refers to a filler Sp including Y, Si, and O. In some embodiments, the filler of the present disclosure excludes Dy₂Si₂O₇.

In some embodiments, at least one of the plurality of disconnected portions Cp may include a filler Sp. That is, as illustrated in FIG. 5, the disconnected portions Cp may be filled entirely with the filler Sp. However, as illustrated in FIG. 5, it is not necessary for all disconnected portions Cp to be filled entirely with the filler Sp.

Referring to FIG. 6, in some embodiments, the disconnected portion Cp may include at least one of a filler Sp, a pore Pp, or a dielectric Dp.

Meanwhile, the pore Pp is an empty space, which can be filled with air, and is a portion in which no bonding force is formed. The dielectric Dp may be a portion of the dielectric layer which is diffused and disposed.

In some embodiments, the dielectric Dp may include the same material as the dielectric layer 111. The dielectric Dp may include BaTiO₃ and (Ba₁₋ₓCaₓ)TiO₃ (0<x<1) as main components.

A region of the internal electrode excluding the disconnected portion Cp may be an electrode portion Ep, and the electrode portion Ep may be formed by sintering a conductive paste for an internal electrode.

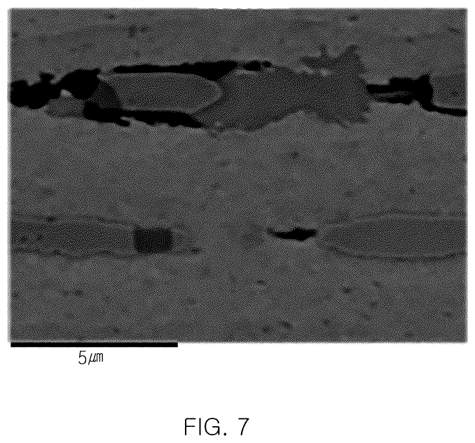

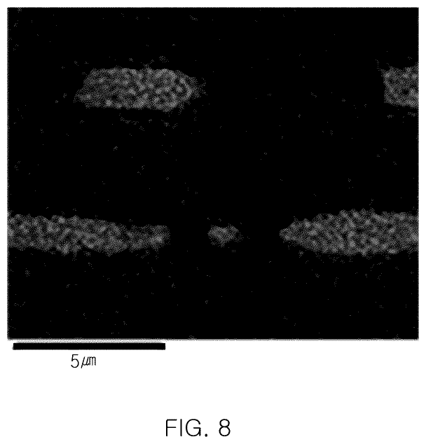

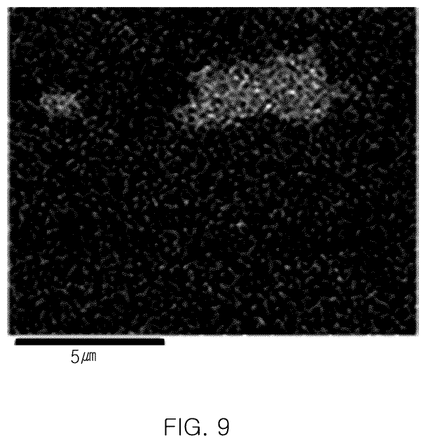

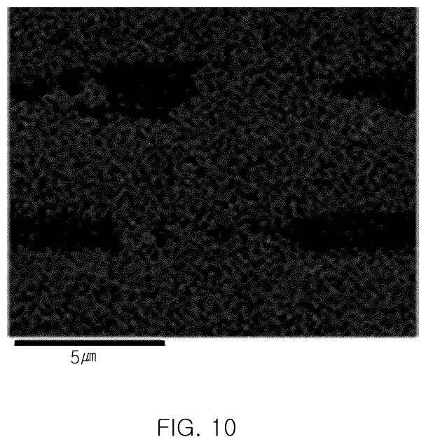

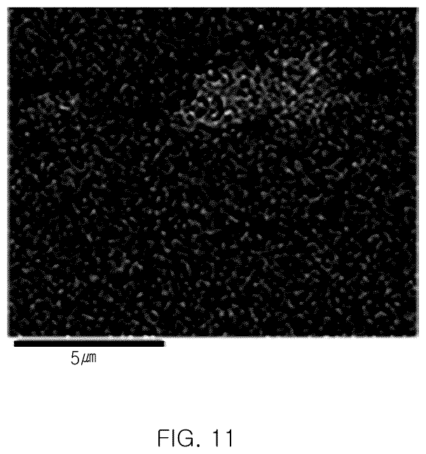

FIG. 7 is an image of an internal electrode according to some embodiments of the present disclosure, scanned by SEM. FIG. 8 is an image of Ni element distribution in the region of FIG. 7, analyzed by SEM-EDS. FIG. 9 is an image of Y element distribution in the region of FIG. 7, analyzed by SEM-EDS. FIG. 10 is an image of O element distribution in the region of FIG. 7, analyzed by SEM-EDS. FIG. 11 is an image of Si element distribution in the region of FIG. 7, analyzed by SEM-EDS.

Referring to FIGS. 7 to 11, it can be confirmed that an Ni element is detected in the electrode portion, and Y, Si, and O are detected and, Y, Si, and a filler Sp is disposed in a long disconnected portion of 1 μm or more.

In some embodiments, the disconnected portion Cp in which the filler Sp is disposed may have a length of 1 μm or more. Since the effect on electrical characteristics and cracks may be significant when the length of the disconnected portion Cp is 1 μm or more, as a filler is disposed in the long disconnected portion having a length of 1 μm or more, the effect of improving the bonding force between adjacent dielectric layers by the filler (Sp) may be further improved, and high-temperature characteristics and thermal stability may be improved more effectively.

In some embodiments, a length ratio of the filler in the disconnected portion may be 20% or more. Accordingly, the high temperature characteristics and thermal stability may be further improved. More preferably, the length ratio of the filler in the disconnected portion may be 50% or more.

Referring to FIG. 6, the length of the entire disconnected portion is the sum of g1, g2, g3, and g4, and the length of the entire filler is the sum of s1, s2, and s3, so the length ratio of the disconnected portion occupied by the filler may be calculated using (s1+s2+s3)/(g1+g2+g3+g4)*100(%).

The length ratio of the filler in the disconnected portion may be measured by scanning images of cross-sections of the body 110 in the first and third directions, cut from a center of the body 110 in the second direction using a scanning electron microscope (SEM). After setting a certain region in the image above, the internal electrode included in the region may be analyzed by SEM-EDS to calculate a length of the disconnected portion and a length of the filler. For example, the region may have sizes in the first and third directions of 30 μm, respectively.

Meanwhile, a length ratio of the pore Pp in the disconnected portion may be 20% or less, and a length ratio of the dielectric Dp in the disconnected portion may be 30% or less.

Referring to FIG. 6, the length of the entire disconnected portion is the sum of g1, g2, g3, and g4, and the length of the entire pore is p1, so the length ratio of pore Pp in the disconnected portion may be calculated using p1/(g1+g2+g3+g4)*100(%).

In addition, the length ratio of the dielectric Dp in the disconnected portion may be calculated using (d1+d2)/(g1+g2+g3+g4)*100(%).

In some embodiments, when a ratio of the length of the electrode portion to the length of the internal electrode is referred to as connectivity of the internal electrode, the internal electrode may have connectivity of the internal electrode of 70% or more and 95% or less.

Referring to FIG. 6, the connectivity of the internal electrode may be a ratio of the length of the electrode portion Ep to the length of the internal electrode (a), and may mean a length ratio of the sum of e1, e2, e3, e4, and e5 relative to a.

Meanwhile, a method of disposing a filler in a disconnected portion is not particularly limited. For example, if Y and Si are added to the internal electrode powder and sintering is performed, the internal electrode starts sintering first, causing disconnection of the internal electrode to occur, and then when grain growth of the dielectric grains of the dielectric layer occurs, Y and Si remaining in the internal electrode bleed out, thereby filling the disconnected portion and forming a filler.

In this case, a content of Y is not particularly limited in some embodiments, the internal electrodes 121 and 122 include ceramic particles, and the content of Y in the filler (Sp) may be 0.1 mol or more and 10 mol or less relative to 100 mol of the ceramic particles.

In some embodiments, the ceramic particles may be disposed within the electrode portion Ep. The ceramic particles may be trapped within the electrode portion and disposed within the electrode portion Ep.

In some embodiments, the dielectric layer 111 and the internal electrodes 121 and 122 may be disposed alternately in a first direction, and the disconnected portion Cp may be disposed to penetrate the internal electrodes in the first direction.

When the disconnected portion Cp is disposed to penetrate the internal electrodes 121 and 122 in the first direction, the occurrence of cracks may be performed easily, so when the disconnected portion Cp is disposed to penetrate the internal electrodes 121 and 122 in the first direction, the effect of suppressing the occurrence of cracks and propagation thereof of the present disclosure may be more significant.

In some embodiments, the filler Sp may be disposed to connect adjacent dielectric layers 111a and 111b. Accordingly, the strength of the multilayer electronic component may be improved by improving bonding force between the dielectric layers 111a and 111b, the occurrence of delamination and cracks may be suppressed, and moisture resistance reliability may be improved.

The internal electrodes 121 and 122 may include first and second internal electrodes 121 and 122. The first and second internal electrodes 121 and 122 may be alternately disposed to oppose each other with the dielectric layer 111 forming the body 110 interposed therebetween, and may be exposed to the third and fourth surfaces 3 and 4 of the body 110, respectively.

The first internal electrode 121 may be spaced apart from the fourth surface 4 and be exposed through the third surface 3, and the second internal electrode 122 may be spaced apart from the third surface 3 and be exposed through the fourth surface 4. A first external electrode 131 may be disposed on the third surface 3 and be connected to the first internal electrode 121, and a second external electrode 132 may be disposed on the fourth surface 4 of the body and be connected to the second internal electrode 122.

That is, the first internal electrode 121 is not connected to the second external electrode 132 but is connected to the first external electrode 131, and the second internal electrode 122 is not connected to the first external electrode 131 but is connected to the second external electrode 132. Therefore, the first internal electrode 121 may be formed to be spaced apart from the fourth surface 4 by a predetermined distance, and the second internal electrode 122 may be formed to be spaced apart from the third surface 3 by a predetermined distance. In addition, the first and second internal electrodes 121 and 122 may formed to be spaced apart from the fifth and sixth surfaces of the body 110.

The conductive metal included in the internal electrodes 121 and 122 may be at least one selected from the group consisting of Ni, Cu, Pd, Ag, Au, Pt, In, Sn, Al, Ti, and alloys thereof, and the present disclosure is not limited thereto. In addition, an appropriate amount of Y and Si may be included in a conductive paste for internal electrodes to dispose a filler in the disconnected portion.

A method of forming the internal electrodes 121 and 122 is not particularly limited. For example, the internal electrodes 121 and 122 may be formed by applying a conductive paste for internal electrodes including a conductive metal, Y, and Si, onto a ceramic green sheet and firing the same. As a printing method of the conductive paste for internal electrodes, a screen-printing method, a gravure printing method, or the like may be used, but an embodiment of the present disclosure is not limited thereto.

An average thickness “the” of the internal electrode is not particularly limited. In this case, the thickness of the internal electrodes 121 and 122 may mean a size of the internal electrodes 121 and 122 in the first direction. For example, when the average thickness “the” of the internal electrodes 121 and 122 is 1.0 μm or less, the effect of suppressing the occurrence and propagation of cracks according to the present disclosure may be more significant.

Here, the average thickness “the” of the internal electrode may be measured by scanning images of cross-sections of the body 110 in the first and second directions with a scanning electron microscope (SEM) at a magnification of 10,000. More specifically, an average value of one internal electrode may be measured by measuring a thickness of one internal electrode at a plurality of points of one of the internal electrodes 121 and 122, for example, at 30 equally spaced points in the second direction. The 30 equally spaced points may be designated in a capacitance formation portion Ac. In addition, if the average value is measured by extending the average value measurement to 10 internal electrodes 121 and 122, the average thickness of the internal electrodes 121 and 122 may be further generalized.

External electrodes 131 and 132 are disposed in the body 110 and connected to internal electrodes 121 and 122.

As illustrated in FIG. 2, the external electrodes 131 and 132 may include first and second external electrodes 131 and 132 respectively disposed on the third and fourth surfaces 3 and 4 of the body 110 and respectively connected to the first and second internal electrodes 121 and 122.

In the present embodiment, a structure in which the multilayer electronic component 100 has two external electrodes 131 and 132 is described. However, the number and shape of the external electrodes 131 and 132 may be changed according to the shape of the internal electrodes 121 and 122 or other purposes.

Meanwhile, the external electrodes 131 and 132 may be formed using any material as long as it has electrical conductivity, such as metal, and a specific material may be determined in consideration of electrical characteristics and structural stability, and furthermore, may have a multilayer structure.

For example, the external electrodes 131 and 132 may be firing electrodes including a conductive metal and glass, or resin-based electrodes including a conductive metal and glass.

For a more specific example of the electrode layers 131a and 132a, the electrode layers 131a and 132a may be sintered electrodes including a conductive metal and glass, or resin-based electrodes including a conductive metal and glass.

In addition, the electrode layers 131a and 132a may have a form in which a sintered electrode and a resin-based electrode are sequentially formed on the body. In addition, the electrode layers 131a and 132a may be formed by transferring a sheet including a conductive metal onto the body, or may be formed by transferring a conductive metal onto the sintered electrode.

A material having excellent electrical conductivity may be used as a conductive metal included in the electrode layers 131a and 132a, and is not particularly limited. For example, the conductive metal may be at least one selected from the group consisting of nickel (Ni), copper (Cu), and alloys thereof.

The plating layers 131b and 132b serve to improve mounting characteristics. A type of the plating layers 131b and 132b is not particularly limited, and may be a plating layer including at least one of Ni, Sn, Pd, and alloys thereof, and may be formed of a plurality of layers.

For a more specific example of the plating layers 131b and 132b, the plating layers 131b and 132b may be a nickel (Ni) plating layer or a tin (Sn) plating layer, may have a form in which a nickel (Ni) plating layer and a tin (Sn) plating layer are sequentially formed on the electrode layers 131a and 132a, or may have a form in which a tin (Sn) plating layer, a nickel (Ni) plating layer, and a tin (Sn) plating layer are sequentially formed. In addition, the plating layers 131b and 132b may include a plurality of Ni plating layers and/or a plurality of Sn plating layers.

As set forth above, according to one of the effects of the present disclosure, by disposing a filler including Y, Si, and O in a disconnected portion of an internal electrode, reliability of a multilayer electronic component may be improved.

However, various advantages and effects of the present disclosure are not limited to the above-described contents, and can be more easily understood in a process of explaining specific embodiments of the present disclosure.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression “an embodiment” used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

While example embodiments have been illustrated and described above, it will be apparent to those skilled in the art that modifications and variations could be made without departing from the scope of the present disclosure as defined by the appended claims.

What is claimed is:

1. A multilayer electronic component, comprising:
a body including a dielectric layer and an internal electrode alternately disposed with the dielectric layer; and
wherein the internal electrode includes a plurality of electrode portions and a plurality of disconnected portions,
a filler including Y, Si, and O is disposed in at least one of the plurality of disconnected portions, and
the dielectric layer includes BaTiO₃ and (Ba₁₋ₓCaₓ)TiO₃, where x is greater than 0 and less than 1.0.

2. The multilayer electronic component of claim 1, wherein a length of at least one of the plurality of disconnected portions in which the filler is disposed is 0.1 μm or more.

3. The multilayer electronic component of claim 1, wherein a length ratio of the filler in the plurality of disconnected portions in which the filler is disposed is 20% or more.

4. The multilayer electronic component of claim 1, wherein the plurality of disconnected portions comprises at least one of a pore, a dielectric, and the filler.

5. The multilayer electronic component of claim 1, wherein the filler comprises at least one of Y₂Si₂O₇ or Y₂Si₂O₅.

6. The multilayer electronic component of claim 1, wherein x satisfies 0.025 or more and 0.2 or less.

7. The multilayer electronic component of claim 1, wherein the dielectric layer includes (Ba₁₋ₓCaₓ)TiO₃ in an amount of 10 mol % or more and 95 mol % or less relative to the total content of BaTiO₃ and (Ba₁₋ₓCaₓ)TiO₃.

8. The multilayer electronic component of claim 1, wherein the internal electrode comprises ceramic particles, and
a content of Y in the filler is 0.1 mol or more and 10 mol or less relative to 100 mol of the ceramic particles.

9. The multilayer electronic component of claim 8, wherein the ceramic particles are disposed within the electrode portion.

10. The multilayer electronic component of claim 1, wherein the dielectric layer and the internal electrode are disposed alternately in a first direction, and
the plurality of disconnected portions is disposed to penetrate the internal electrode in the first direction.

11. The multilayer electronic component of claim 1, wherein the filler is disposed to connect dielectric layers adjacent to one of the plurality of disconnected portions in which the filler is disposed.

12. The multilayer electronic component of claim 1, wherein at least one of the plurality of disconnected portions includes the filler.

13. The multilayer electronic component of claim 1, wherein at least one of the plurality of disconnected portions comprises a dielectric, wherein the dielectric comprises BaTiO₃ and (Ba₁₋ₓCaₓ)TiO₃ (0<x<1) as main components.
